(19) United States
(12) Patent Application Publication
(10) Pub. No.: US 2010/0217712 A1
(43) Pub. Date: Aug. 26, 2010

(54) Method for Sales Forecasting in Business-to-Business Sales Management

(76) Inventor: PETER R. FILLMORE, Kanata (CA)

Correspondence Address: J. GORDON THOMSON, P.O. BOX 8865, VICTORIA, BC, V8V 3Z1, CA

(21) Appl. No.: 12/711,097

(22) Filed: Feb. 23, 2010

Related U.S. Application Data
(60) Provisional application No. 61/154,976, filed on Feb. 24, 2009.

(51) Int. Cl. G06Q 10/00; G06Q 30/00; G06N 5/02

(52) U.S. Cl. 705/80; 705/7; 705/8; 705/10; 705/11; 706/47

(57) ABSTRACT

The invention provides a system and method for analyzing data from sales staff for multiple active business-to-business (B2B) sales opportunities—and generating a sales revenue forecast, along with additional valuable information to give the business management insight into future potential changes in revenue. The present invention lets a user define stages of selling progress based on steps known as Customer Decision Elements (CDEs) that deliver value to the customer's decision-making process, as input data, as well as the dollar value of the active sales opportunity. The sales progress in completing these defined stages is also entered into the system of the present invention.

### CROSS-REFERENCE TO PREVIOUSLY FILED APPLICATIONS

This patent application claims the benefit of U.S. Provisional Patent Application No. 61/154,976 filed on Feb. 24, 2009.

### FIELD OF THE INVENTION

The present invention relates to the field of data processing: financial, business practice, management or cost/price determination. Specifically, this invention relates to a method for sales forecasting in business-to-business sales management.

### BACKGROUND OF THE INVENTION

In the area of sales and revenue forecasting, every business has a need to estimate future sales. This requires the production of a sales forecast that is used to predict whether cash from sales will meet or exceed the ongoing costs of operating the business. Furthermore, it is necessary to determine what level of parts inventory, finished goods inventory and human resources will be needed to meet customer demands. These forecasts are used to report to shareholders. In the case of public companies these forecasts have a high level of visibility and are used by market analysts and shareholders to estimate future profit levels. Hence, the forecasts can be determinative of appropriate share values for trading on public markets.

When sales activities involve capital acquisitions or large projects sold by one enterprise to another (know as business-to-business sales, or B2B sales) the purchasing decisions by customers typically only happen after a long period of deliberation and negotiation. This period can be from several months to several years. Current sales forecasting systems typically employ a tabular summary of opportunities, with an estimated dollar amount, estimated closing date, and estimated percent probability of closing a contract. Depending on the scope of the selling organization, and the variety of their products, the forecasting system may need to produce forecast reports by region as well as by product since all parts of the enterprise plan their future resources and activities by the sales forecast.

Methods in current use typically involve a sales person's judgment on what is the percent probability of closing, and the closing date, at the level of each line item in the opportunity list. Sales progress is often tracked by conveniently measurable activities in the sales work, such as doing a product demonstration or writing a vendor proposal. These practices tend to provide a poor basis for forecast accuracy, and a tracking system that includes many instances of data that are out of date. Therefore a need has arisen for a new system and method for organizing sales progress information, and analyzing the data to get sales forecasts that are consistently accurate.

Managers of organizations selling large projects (e.g. over $50,000 order value or over $50,000 life cycle decision) often have difficulty estimating the future sales revenues that may flow from a list of current sales activities. Inaccurate sales forecasts are the norm, and it is common for management to just apply an arbitrary “discount” to forecasts that are often too optimistic, to derive the planning number that is sent up to senior executives and operations planning management. Underlying changes in sales momentum are usually lost in the mass of data involving hundreds of situations, and miscalculations are common. These miscalculations can be very damaging to the selling organization, involving wasted resources to build the wrong amount or type of products, or to misjudge the financial resources available from sales to supply the company over the coming time periods. In public companies this can be very damaging to management credibility as well, and often leads to sudden share price drops, when sales forecasts are not met.

### SUMMARY OF THE INVENTION

The method of the present invention provides an analysis of sales progress data from an organization's sales staff for multiple active business-to-business opportunities. The method of the invention then generates a sales revenue forecast with additional valuable information to provide management insight into future potential changes in sales revenue.

The key elements of the method of the invention include:
1. Sales Progress is tracked based on progress against the typical Customer Decision Elements (CDEs), that include:
   a. completion of a document describing customer need(s) and business problem(s) to be solved
   b. analysis, with customer and vendor involved, of the potential value to the buyer organization if the need(s) can be addressed
   c. confirmation for the customer, by demonstration or references and specifications, that the vendor's products and/or services can be an effective solution for the identified need(s)
   d. identification of timing elements in the customer's activity plans that determine an optimum time to acquire and implement the vendor's solution, and the creation of a written plan of implementation activities by both the customer and vendor, including the date upon which the customer expects to place a firm order with the vendor, and the management agreement of people authorized to commit the estimated amount of customer funding
   e. customer budget approval for the project or product acquisition
   f. other stages of customer decision approval—the system design allows provision for additional stages to be named, and incorporated into the overall system and method
2. The data on sales progress is organized in an opportunity list, in a tabular or spreadsheet format, that employs several columns to track sales progress against the CDEs. The table contains provision for identifying the sales region, unit or person responsible for each opportunity, as well as information about products and services that are potentially included in the sale.
3. A number of decision rules are provided to the operator, to support consistent definition of selling stage progress, and to identify the conditions under which an order closing date will be allowed as data input.
4. The system uses the Sales Progress information, with each stage expressed as a fraction of 100, to calculate a Progress Value for each line item, and the aggregate of progress values as a Funnel Value for each group of items in the table, and for the entire table of the opportunity list items. Information is separated into dated and undated line items, for different treatment in developing a sale forecast. Forecasting is done in two parts:
   a. A short term forecast (usually 3 months) using only dated items for the short term period of time, and
   b. A Medium Term forecast for a further period of time (usually 6 to 12 months) using the remaining dated items, the undated items and a momentum adjustment, and considering the historical length of the time required for a complete sell cycle, for an acquisition of the approximate dollar value, as applied to each undated line item.
5. The system tracks Funnel Value and how it changes from one time period to the next. The changes in the funnel value metric are defined as “Momentum Trend” and used to generate a momentum adjustment for use in the Sales Forecast calculations.
6. The adjustment factors considered in the sales forecast calculations include:
   a. Momentum Trend—used by calculating % change in Momentum for an xx Months sell cycle duration, and applying that % change to the previous xx month's total sales—to calculate the estimated upper limit of the next xx month's forecasted total sales.
   b. Stage Distribution of current funnel value total amount (seen as the shape of a bar chart for funnel value at each of the stages of sales progress)—used to estimate the distribution over time of the next xx month's total sales—with the latest-stage progress items included in an estimate for the earliest period future sales, and the earliest-stage progress items included in an estimate for the latest period future sales.
   c. Estimated length of the sales cycle, for deals of a given dollar value range—used in both the Momentum changes and Stage Distribution calculations above, to derive any calculations of the timing of future sales estimates or forecasts
7. The system also provides search and extraction tools to show an operator a subset of the data available—e.g. the Sales Forecast, Momentum Trend and/or other metrics for a given sales region or unit, or a group thereof, or for a given product or group of products.
8. The system and method also provide for the display of useful sales tracking and forecasting information as a management dashboard or presentation format useful to the operating organization's management for keeping aware of sales progress and getting early warnings of adverse conditions, to assist in planning corrective action.

### BRIEF DESCRIPTION OF THE FIGURES

FIG. 1 is a flow chart of a method of generating sales forecasts according to an embodiment of the present invention.

FIG. 2 is a sample of a simple Sales Opportunity list, showing Stages of progress, weighted values calculated, and a summary of overall funnel value for the list of items

FIG. 3 is a summary of typical funnel value trend over 6 time periods, used to observe changes in sales momentum

FIG. 4 is a view of a typical sales opportunity list, showing extensions (added columns) to show the generated data for funnel value, separating dated items from undated items, as a step in sales forecast generation

FIG. 5 is a block diagram of the major physical and software arrangement components of the system

### DETAILED DESCRIPTION OF PRESENTLY PREFERRED EMBODIMENTS

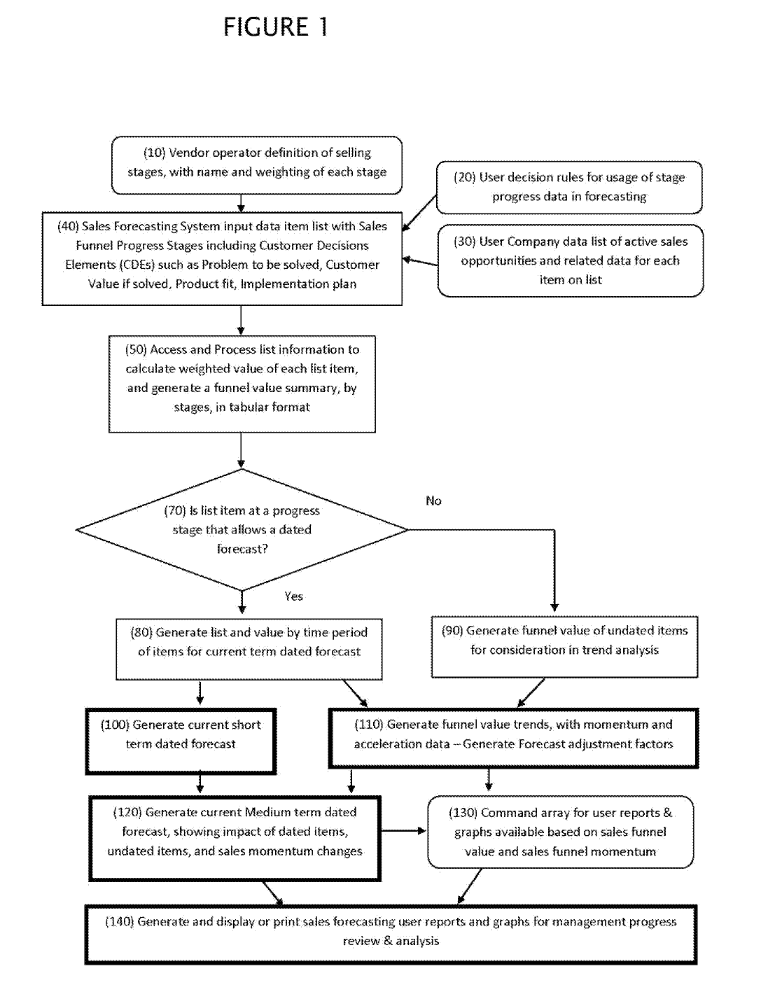

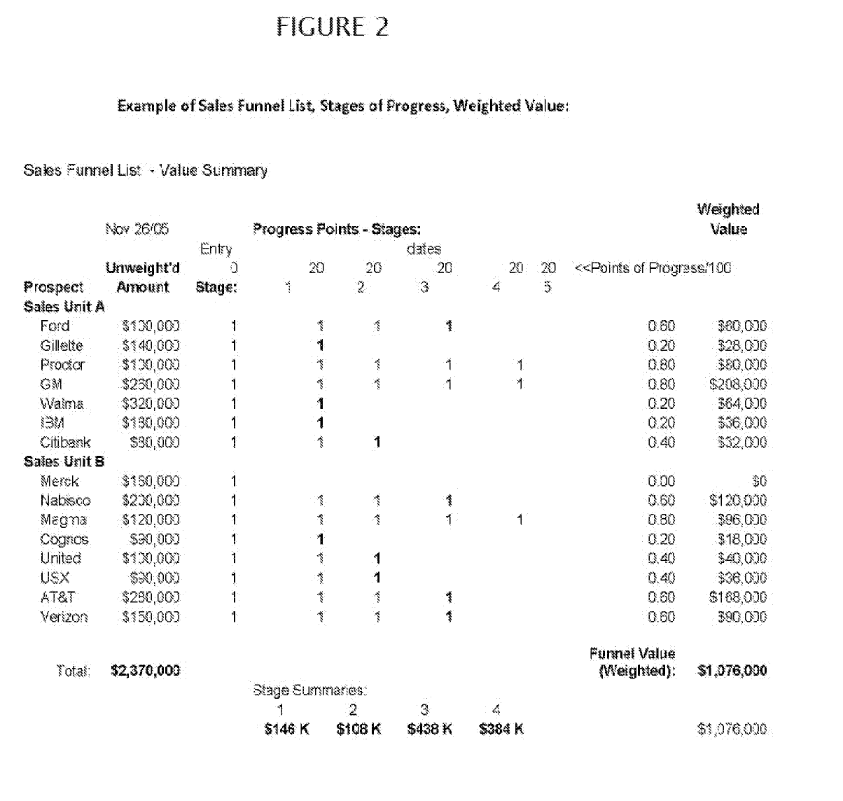

With reference to FIG. 1, the steps 10, 20, and 30 depict the primary data inputs to the system, according to an embodiment of the present invention, as follows:
In Step 10 the vendor organization (operator) supplies information on the number of selling stages (usually 5 to 10) and the terminology used to identify those stages. The stages will include Customer Decision Elements (CDEs) such as acceptable work with the customer to define
   Customer Problem to be solved, and
   Value and business case for solving the problem, and
   Vendor product or offer fit, in terms of its ability to solve the defined Problem, and
   Plan of Implementation, with dates agreed by the Customer
   Other typical stages of customer decision development
Step 20 depicts an example of the operator decision rules for the entry and updating of stage progress information, for any given item on the opportunity list. For example a rule may be that each of the stages of progress must be confirmed by a correspondence with the customer, and a confirmation from the customer (at appropriate levels of management) that they agree. One rule may be the progress criteria for an operator to assign a projected closing date to a line item. Another rule may be that direct competition must not be a factor if an opportunity is to be stated at any progress level over 50 points out of 100. Another rule may be that when an item is closed as a firm customer order, it is immediately removed from the sales funnel, and hence removed from funnel value and funnel momentum calculations.
Step 30 depicts the basic entry, and updating, of the information on each line item on the sales opportunity list. The related data will include basic information on the un-weighted dollar value of the sale, and the progress stage(s) completed, an example of which is shown in FIG. 2. Additional data may include the name of the sales person or business unit responsible for that account, the product or products being offered, and the date the opportunity was entered.

In Step 40 the input data is organized into a tabular format that can be presented to the operator as a summary list of active opportunities. The tabular format will include separate columns for each selling stage, with consideration of the key Customer Decision Elements described above for Step 10.

Step 50 depicts the determination, based on stage progress and decision rules, of weighted value for each list item, the summary of items at each stage of progress, and the aggregate weighted funnel value for all items in the sales funnel. Additional useful calculations may be done depending on the scope of the business operations and product lines—for example aggregate information summaries by sales unit or by product line.

The Step 70 depicts a separation of list items into two types, those with a dated forecast, and those without a date.

Step 80 depicts the internal calculations to generate a list of items by time period, using only the dated items.

Step 100 depicts the generation of data for a short term Sales Forecast over the particular time period of interest to the operator. This will typically be for a 3 month period—i.e. showing one business quarter—and be broken down by month 1, 2, and 3. The Forecast may also be for a longer period—e.g. 6 months—broken down month-by-month.

In a parallel stream of analysis, Step 90 shows the generation of funnel value numbers for undated items in the overall list. These will be used in calculations of Momentum Trends and momentum changes in funnel value.

Step 110 shows the use of both dated items, and undated items, to calculate overall funnel value, and track changes over time to derive funnel value, Momentum Trends, and the pace of changes in Momentum, know as acceleration or deceleration, to generate Forecast adjustment factors. The information produced here is available to a medium term forecasting operation, and also to a command array for operators to produce management reports and graphs.

Step 120 depicts the generation of a medium term forecast, using data from two sources, the short term forecast and the overall funnel value, momentum and adjustment factor information coming from the Step 110 calculations.

Step 130 shows the provision of user commands in a command array allowing the extraction of reports on an ad hoc basis, above and beyond the standard periodic forecasting reports, such as an analysis of funnel value, momentum, and acceleration for a particular sales unit or a particular product line.

Step 140 depicts the generation and display of operator reports for system users, as well as graphical portrayals of the data, to assist in management progress review and analysis. This includes standard reports as well as ad hoc extraction of particular views of the data, as specified by the operator in Step 130.

The FIG. 2 shows a typical tabular summary of data for a sales forecasting summary. Sample customer names, and potential order value are shown. At the time of entry (addition of a new opportunity line item) the situation is considered “qualified” by sales management as one that may lead to an order, with the customer contact person showing specific interest and motivation to work with the vendor. In this example 5 stages are shown as column headings, numbered by Stage codes 1 to 5. The stages are based on Customer Decision Elements (CDEs). The description of the stages in this example would be as follows:
Stage 1—Customer Problem to be solved, written and agreed by the customer
Stage 2—Payback value analysis; estimates of customer value in solving the problem
Stage 3—Product or offer fit; may be a demo or specification sheet showing ability to solve the defined customer problem
Stage 4—Plan of Implementation, with dates agreed by the Customer
Stage 5—Contract signed

Other stages may be added as they are determined to be needed by the operator. The system shows useful summary totals such as the summary of un-weighted value of all situations (bottom left), the summary (at right side) of weighted value for each line item, and the summary of funnel value for all items at each stage of progress (along the bottom).

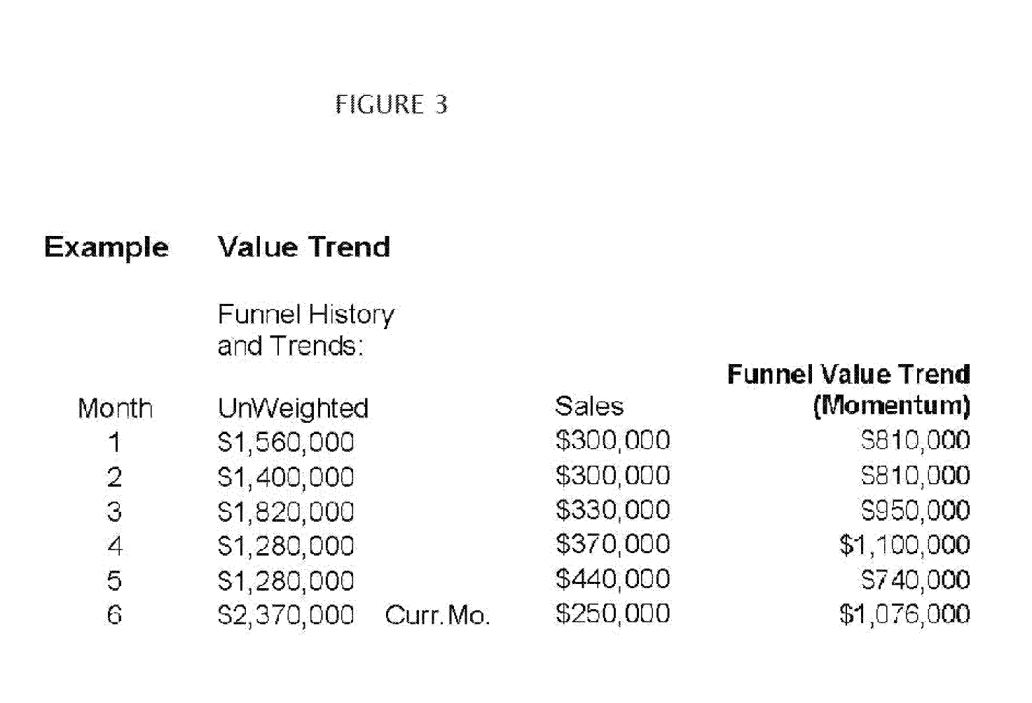

The FIG. 3 shows a simple summary of typical data for a sales funnel history—in this case over a 6 month period. The three columns show:
Un-weighted funnel value—for each period
Actual Sales Closed—for each period
Funnel Value—Calculated at the end of each period

The trend of Funnel Value shows variations that are defined as “momentum”, and changes in momentum are very significant in providing early warning of changes in rate of sales closings. All these data can be presented in graphical format to improve clarity in management analysis. In addition, the changes in momentum may be fed back into the medium term sales forecast as an adjustment on the forecast estimates, upward or downward based on observed momentum changes.

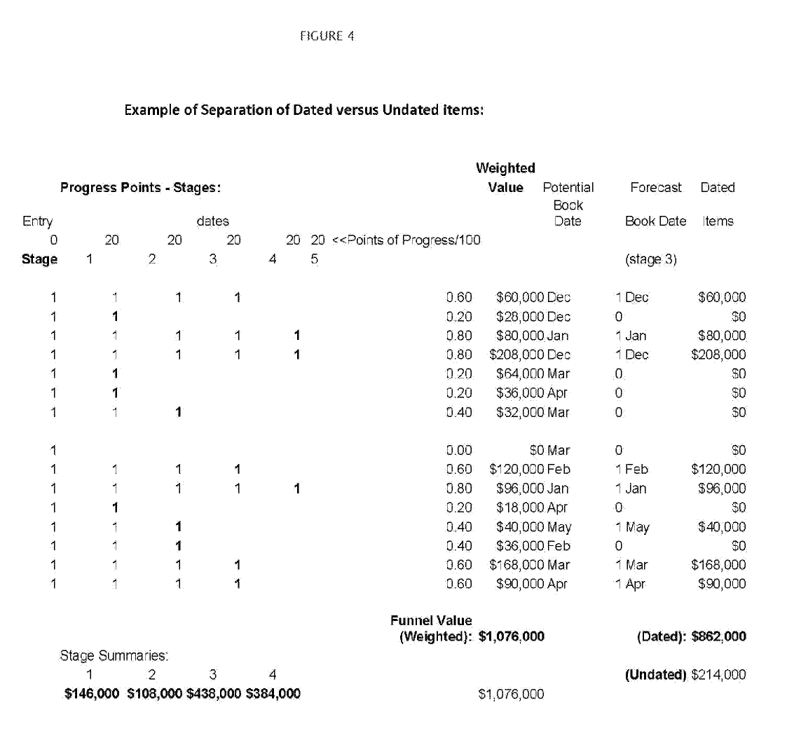

The FIG. 4 shows an extension, to the right side, of FIG. 2—adding columns illustrating other data that is generated when the list is separated into dated and undated items. In this case the right two columns show forecasted booking (closing) dates for dated items, and the weighted value of dated items. This becomes the data which is then re-organized into a list by month, for purposes of generating the short term forecast, showing dollar value by month.

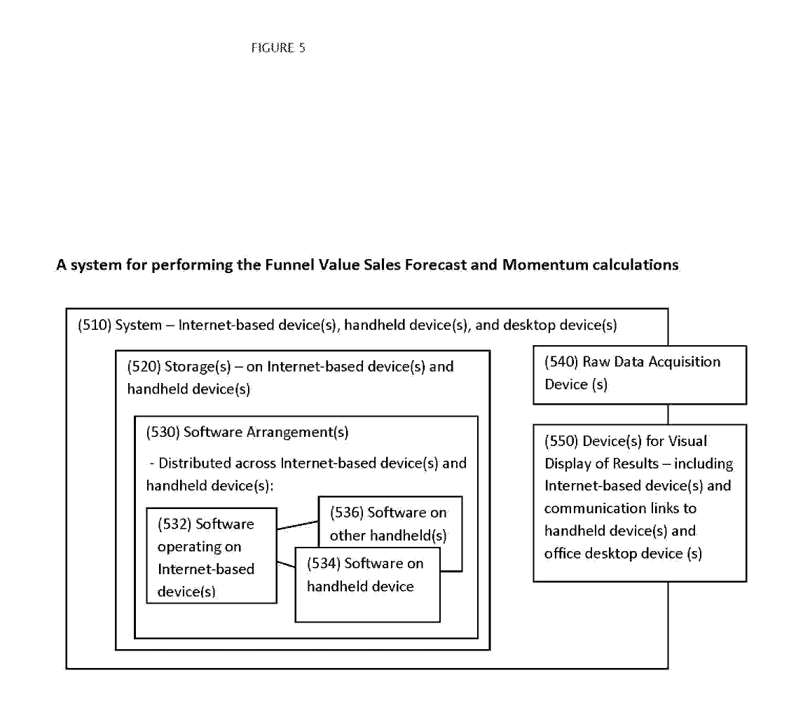

The FIG. 5 depicts a system (500) for calculating a sales forecast and sales momentum based on funnel value according to an embodiment of the present invention. The system (500) may include a storage device or devices (520) (e.g. hard drive disk device, random access memory {RAM}) that store(s) a software arrangement (530), and have (has) a processing system(s) (510) (e.g. a microprocessor). A software arrangement (530) may be executed by processing system(s) (510) to calculate funnel value for line items, aggregate sales forecasting and sales momentum data, and other useful information, for the B2B sales forecasting system in the above-described embodiment of the invention. The systems (510) may include multiple types of hardware devices, one being an Internet-based Server that runs a single instance of the database software arrangement that manages the data repository of all users, while allowing each user to have private access to their own data, according to a set of access rules set up in the system, for each user or user group. Additional hardware devices may be used, such as a smart phone type of handheld device(s), with those devices providing a way to rapidly enter data from multiple users in different places and times, and providing the hardware facilities to operate some parts of the software arrangement, doing the processing, calculations and display locally for selected parts of the operations that will provide mobile convenience to the user, and free the user of complete dependence on the Internet link being in operation, or the need to be at a desk with a desktop system.

The overall system also includes a data input mechanism or mechanisms (540) for allowing the operator to feed raw data on customer list item into the system, as well as a display and/or print-out device(s) (550) to present the sales forecast results and other requested operator management reports.

The system and method includes the ability to search the available data for subsets of the data deemed useful by the operator in a user company or organization. The system and method also includes the ability to flexibly portray the summary data or any available data in a view of key sales and sales forecast information (sometimes known as a management dashboard), using numeric, graphical, and animated techniques to assist viewers in rapid comprehension of the data, the implications of the data, and potential corrective actions for management to consider.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method for sales forecasting in business to business sales management for a plurality of business sales opportunities, said method performed on a computer, the method comprising the following data input steps:
a. identification of each sales opportunity of said plurality of sales opportunities; and,
b. identification of selling stages for each of said sales opportunities.

2. The method of claim 1 wherein said data input step of identification of each sales opportunity of the plurality of sales opportunities includes the following steps:
a. identification of a customer associated with each of the sales opportunities;
b. estimating the dollar value for each of the sales opportunities;
c. identifying the sales team associated with each of the sales opportunities;
d. identifying the products associated with each of the sales opportunities; and,
e. identifying the current progress of each of the sales opportunities.

3. The method of claim 1 wherein said data input step of identification of said selling stages for each of the sales opportunities includes the following steps:
a. identification of customer decision elements for each of the sales opportunities wherein said customer decision elements comprise:
i. identification of a customer problem to be solved;
ii. identifying the value of said problem solution to the customer;
iii. determining an at least one product to solve the problem; and,
iv. developing an implementation plan to apply said product(s) to the problem;
b. applying a set of customer based rules to the customer decision elements for tracking the progress of the customer decision elements, said set of customer based rules comprising:
i. confirming to the customer the completion of an individual customer decision element;
ii. assigning a closing date to each customer decision element;
iii. confirmation of customer budget approval for the product; and,
iv. execution of a sales contract with customer;
c. applying a time delay to each customer decision element.

4. The method of claim 3 further comprising the step of tabulating each sales opportunity against the customer decision elements for tracking sales progress.

5. The method of claim 4 further comprising the step of assigning a weight factor to each customer decision element so that as a customer decision element is achieved said weight factor is applied against the dollar value of each sales opportunity the result being an accumulative weighted dollar value of each sales opportunity for each customer decision element.

6. The method of claim 5 wherein the weight factor is identical for each customer decision element.

7. The method of claim 6 further comprising the step of determining a progress value for each of the sales opportunities wherein the step comprises the steps of summing the weight factors for each completed customer decision element for each of the sales opportunities and expressing the sum as said progress value.

8. The method of claim 7 further comprising the step of determining a funnel value for said plurality of business opportunities wherein the step comprises summing said progress value for each business opportunity of the plurality of business opportunities.

9. The method of claim 8 further comprising the step of performing a short-term sales forecast comprising the following steps:
a. selecting the business opportunity line items where a future customer decision date is included in a completed implementation plan for that line item, to be used for the short-term forecast;
b. determining a progress value for each business opportunity at said future customer decision date;
c. determining an array of dated funnel values by summing said progress value for each business opportunity showing said future customer decision as completed on the date;
d. taking said array of dated funnel values, over a selected short term period, as said short-term sales forecast.

10. The method of claim 9 further comprising the step of performing a medium-term sales forecast comprising the following steps:
a. determining an undated funnel value by summing the progress value for each business opportunity showing said implementation plan customer decision element as incomplete;
b. summing the dated funnel value and said undated funnel value to obtain a sum;
c. applying a momentum trend factor, and the time length of a typical sales cycle, and the stage distribution of current figures in the funnel value, to said sum to obtain a medium-term sales forecast over future time periods, for undated items; and,
d. Adding the dated funnel value items of claim 9 which are outside the selected short term forecasting period to the said undated items of medium-term sales forecast to obtain an array of forecast values over time, for all opportunities outside the selected short term period.

11. A computer program for sales forecasting in business to business sales management for a plurality of business sales opportunities, said program comprising:
a. means for the identification of each sales opportunity of said plurality of sales opportunities; and,
b. means for identification of selling stages for each of said sales opportunities.

12. The computer program of claim 11 wherein said means for identification of each sales opportunity of the plurality of sales opportunities includes:
a. means for the identification of a customer associated with each of the sales opportunities;
b. means for estimating the dollar value for each of the sales opportunities;
c. means for identifying the sales team associated with each of the sales opportunities;
d. means for identifying the products associated with each of the sales opportunities; and,
e. means for identifying the current progress of each of the sales opportunities.

13. The computer program of claim 11 wherein said means for identification of said selling stages for each of the sales opportunities includes the following:
a. means for identification of customer decision elements for each of the sales opportunities wherein said customer decision elements comprise:
i. means for identification of a customer problem to be solved;
ii. means for identifying the value of said problem solution to the customer;
iii. means for determining an at least one product to solve the problem; and,
iv. means for developing an implementation plan to apply said product to the problem;
b. means for applying a set of customer based rules to the customer decision elements for tracking the progress of the customer decision elements, said set of customer based rules comprising:
i. means for confirming to the customer the completion of an individual customer decision element;
ii. means for assigning a closing date to each customer decision element;
iii. means for confirmation of customer budget approval for the product; and,
iv. means for execution of a sales contract with customer;
c. means for applying a time delay to each customer decision element.

14. The computer program of claim 13 further comprising means for tabulating each sales opportunity against the customer decision elements for tracking sales progress.

15. The computer program of claim 14 further comprising means for assigning a weight factor to each customer decision element so that as a customer decision element is achieved said weight factor is applied against the dollar value of each sales opportunity the result being an accumulative weighted dollar value of each sales opportunity for each customer decision element.

16. The computer program of claim 15 wherein the weight factor is identical for each customer decision element.

17. The computer program of claim 16 further comprising means for determining a progress value for each of the sales opportunities wherein said means comprises the summing of the weight factors for each completed customer decision element for each of the sales opportunities and expressing the sum as said progress value.

18. The computer program of claim 17 further comprising means for determining a funnel value for said plurality of business opportunities comprising summing said progress value for each business opportunity of the plurality of business opportunities.

19. The computer program of claim 18 further comprising means for performing a short-term sales forecast comprising:
a. means for selecting the business opportunity line items with a future customer decision element date for inclusion in a short-term forecast;
b. means for determining a progress value for each business opportunity at said future customer decision element date;
c. means for determining an array, over time, of dated funnel value by summing said progress value for each business opportunity expected to close in selected short term future time periods, showing said customer decision element as completed on the date; and,
d. means for taking said array of dated funnel values as said short-term sales forecast.

20. The computer program of claim 19 further comprising means performing a medium-term sales forecast comprising:
a. means for determining an undated funnel value by summing the progress value for each business opportunity showing said customer decision element as incomplete on the date;
b. means for summing the dated funnel value for items outside the selected short term forecast period, and said undated funnel value to obtain a sum; and,
c. means for applying a momentum factor and the time length of a typical sales cycle, and the stage distribution of current figures in the funnel value, to said sum, placing each funnel value item in the appropriate future time period to obtain said medium-term sales forecast.
